(19) United States
(12) Patent Application Publication
(10) Pub. No.: US 2012/0102059 A1
(43) Pub. Date: Apr. 26, 2012

(54) OPTICAL FIBER OPTIMIZATION SYSTEM

(75) Inventors: David Zhi Chen, Richardson, TX (US); Mark Anthony Ali, Cockeysville, MD (US); George N. Bell, Stormville, NY (US)

(73) Assignee: VERIZON PATENT AND LICENSING INC., Basking Ridge, NJ (US)

(21) Appl. No.: 12/908,947

(22) Filed: Oct. 21, 2010

(51) Int. Cl. G06F 15/00; G06F 17/30

(52) U.S. Cl. 707/765; 702/182; 707/770; 707/E17.014

(57) ABSTRACT

A computing-device implemented method may include performing one or more measurements for a number of optical fiber components. The one or more measurements may be stored. A performance matrix may be generated by at least one processor, based on the one or more measurements, wherein the performance matrix includes measured and estimated performance metrics for combinations of the number of optical fiber components. Suitability of a planned fiber optic installation that includes a number of components may be determined based on the performance matrix. One or more recommended fiber optic components may be determined based on the performance matrix.

### BACKGROUND INFORMATION

Modern fiber optic networks and telecommunications infrastructure require a large number of different and complex components. These components come in a variety of different types and from a number of different manufacturers. Given the nanometer scale in which fiber optic equipment operates, even minor differences in specifications and component performance may have a significant impact on the overall installation performance.

More specifically, splicing or terminating optical fibers with mechanical splices and mechanical splice-on connectors often has a significant negative impact on resulting optical performance. The performance degradation may be caused by the mechanical splice itself, the fiber cleave angle or the joint effect. Major factors contributing to this optical performance degradation when using mechanical splices and mechanical splice-on connectors include fiber eccentricity, fiber effective area, fiber diameter, fiber cleave angle, fiber alignment, fiber joint, index matching gel used, connector keying, etc.

Further contributing factors that negatively impact optical performance includes the use of different manufacturers and manufacturing processes, process tolerances and optical link length. These factors all combine to negatively impact network optical performance such as insertion loss (IL), return loss (RL), and wavelength dependent loss (WDL). Such differences make planning for and implementing fiber installations extremely difficult.

### BRIEF DESCRIPTION OF THE DRAWINGS

FIG. 1 illustrates an exemplary environment in which systems and methods described herein may be implemented;

FIG. 2 illustrates is a diagram of an exemplary device of FIG. 1;

FIGS. 3A and 3B are schematic block diagrams illustrating a first fiber test data collection technique;

FIG. 4 is a flow diagram illustrating exemplary processing associated with the first fiber test data collection technique of FIGS. 3A and 3B;

FIGS. 5A and 5B are schematic block diagrams illustrating a second fiber test data collection technique;

FIG. 6 is a flow diagram illustrating exemplary processing associated with the second fiber test data collection technique of FIGS. 5A and 5B;

FIGS. 7A and 7B are schematic block diagrams illustrating a third fiber test data collection technique;

FIG. 8 is a flow diagram illustrating exemplary processing associated with the third fiber test data collection technique of FIGS. 7A and 7B;

FIGS. 9A and 9B are schematic block diagrams illustrating a fourth fiber test data collection technique;

FIG. 10 is a flow diagram illustrating exemplary processing associated with the fourth fiber test data collection technique of FIGS. 9A and 9B;

FIG. 11 is a functional block diagram of exemplary components implemented in the fiber optimization system of FIG. 1; and

FIG. 12 is a flow diagram illustrating exemplary processing associated with providing fiber and equipment suitability calculations and/or recommendations consistent with implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Embodiments described herein relate to systems and methods for implementing fiber optic component testing and optimization analysis. In one exemplary implementation, a system may be provided in which mechanical splices and mechanical splice-on connectors, pigtails and jumpers from different manufacturers are characterized by measurements and attributes that are stored as a matrix in a retrieval system. The performance matrices may be used to calculate and/or estimate fiber optic component suitability and recommendations for various combinations of fiber optic components. The stored matrix may allow a user to identify a product and manufacturer for a specific network installation by inputting the appropriate network performance requirements or other criteria.

The fiber optimization system may receive requests for planned fiber installation component suitability. The fiber optimization system may 1) determine whether the planned installation components are suitable (e.g., relative to a predetermined metric) or 2) provide recommendations for ensuring suitable installations. In some instances, users may be enabled to conduct “what if?” or queries in which the user changes the input scenarios and the system responds with outputs based on the matrix data stored in the retrieval system.

The fiber optimization system will respond by outputting possible solutions based on the matrix data stored in the retrieval system. By providing a unified and easy to use system for determining component suitability and recommendations, implementations described herein may improve the ability of telecommunications installers to determine appropriate and suitable components for installation.

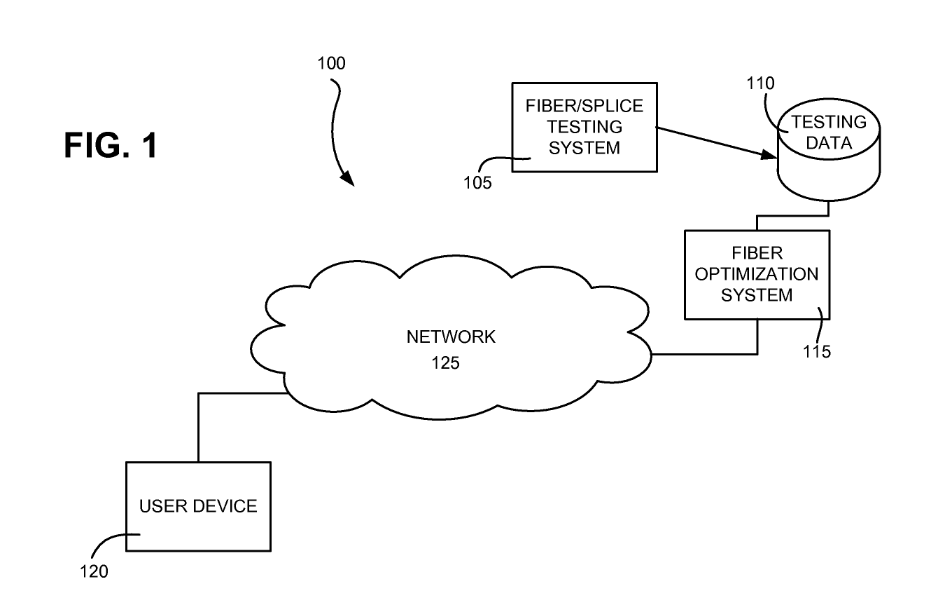

FIG. 1 is a block diagram of an exemplary environment 100 in which systems and methods described herein may be implemented. As shown, environment 100 may include a fiber/splice testing system 105, a testing data storage device 110, a fiber optimization system 115, and a user device 120 connected to fiber optimization system 115 via a network 125.

Consistent with embodiments described herein, fiber/splice testing system 105 may include one or more devices for testing or measuring optical fiber and splice characteristics, such as optical signal power, signal loss (e.g., wavelength dependent loss (WDL)), etc. For example, in some implementations, fiber/splice testing system 105 may include an optical signal meter device having a transmitter for outputting an optical signal to a test optical fiber at a predefined wavelength. The optical signal meter device may also include a receiver for receiving the optical signal after it passes through the test fiber. Characteristics of the test fiber, such as signal losses, etc. may then be calculated or determined based on, for example, differences between the output signal and the received signal. An exemplary optical signal meter device may include a spectrum analyzer, or other suitable device for measuring optical signal power.

Fiber/splice testing system 105 may further include a data entry device for capturing the fiber/splice measurement data calculated or obtained by receiving the optical signal from the metering device and transmitting the data to testing data storage device 110. In some implementations, testing data storage device 110 may be connected to fiber/splice testing system 105 via a computer network (such as network 125). In other implementations, testing data storage device 110 may be co-located with fiber/splice testing system 105.

Fiber optimization system 115 may include one or more devices for providing equipment recommendations to users based on the fiber/splice measurement data collected by fiber/splice testing system 105 and stored in testing data storage device 110. For example, fiber optimization system 115 may include one or more server devices for connecting to user devices 120 (one of which is shown in FIG. 1) via network 125. The server devices may receive product recommendation requests from user device 120 via network 125.

User device 120 may include any device capable of connecting to fiber optimization system 115 via network 125. For example, user device 120 may include a personal computer, a mobile phone, a smart phone, a laptop or notebook computer, a gaming device, a netbook, a tablet computer, etc.

Network 125 may include a local area network (LAN), a wide area network (WAN), a metropolitan area network (MAN), a telephone network, such as the Public Switched Telephone Network (PSTN), an intranet, the Internet, an optical fiber (or fiber optic)-based network, or a combination of networks.

Consistent with embodiments described herein, user device 120 may receive a user request for product recommendations via an interface application, such as a web browser, or other suitable application. In some implementations, the request for product recommendations may include fiber parameter information, such as existing equipment information, cost criteria information, installation information (e.g., fiber length requirements, field limitation information (e.g., types of splicing capabilities), etc.), etc. The request may be transmitted to fiber optimization system 115 via network 125.

Fiber optimization system 115 may receive the product recommendation request from user device 120 and, based on the fiber testing data stored in testing data storage device 110, make one or more product/equipment recommendations that satisfy the input parameters and one or more network requirements. Network requirements include maximum allowed signal losses (e.g., maximum insertion loss IL, minimum return loss RL, maximum WDL), etc.

The exemplary configuration illustrated in FIG. 1 is provided for simplicity. It should be understood that a typical implementation environment may include more or fewer devices than those illustrated in FIG. 1. For example, other devices that facilitate communications between the various entities illustrated in FIG. 1 may also be included in environment 100. In addition, although a single fiber/splice testing system 105, testing data storage device 110, fiber optimization system 115, user device 120, and network 125 have been illustrated in FIG. 1 for simplicity, in operation, there may be more single fiber/splice testing systems 105, testing data storage devices 110, fiber optimization systems 115, user devices 120, and networks 125. Also, in some instances, one or more of the components of environment 100 may perform one or more functions described as being performed by another one or more of the components of environment 100.

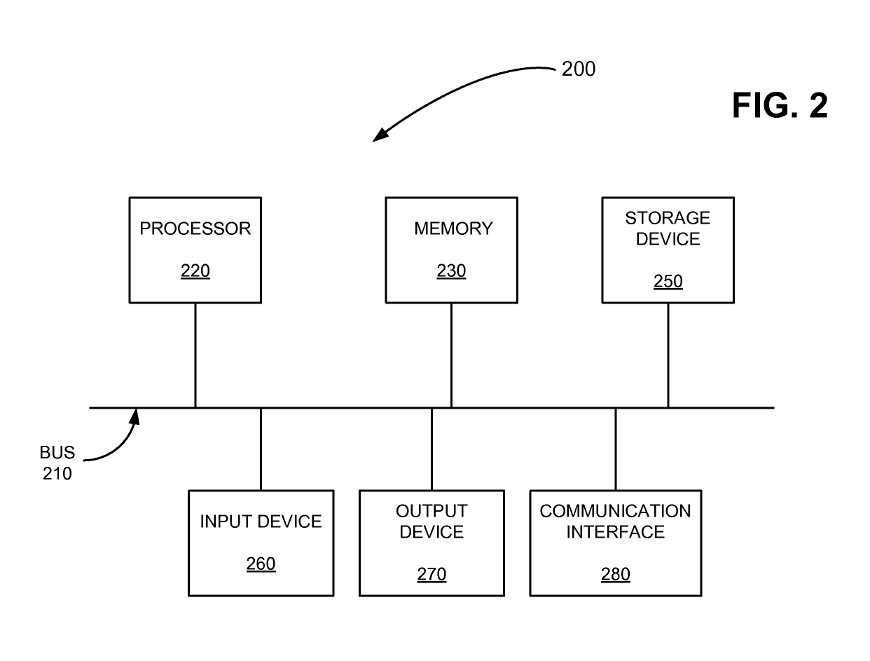

FIG. 2 is an exemplary diagram of a device 200 that may correspond to one or more devices in fiber/splice testing system 105, fiber optimization system 115, and/or user device 120. As illustrated, device 200 may include a bus 210, processor 220, memory 230, storage device 250, input device 260, output device 270, and/or communication interface 280. Bus 210 may include a path that permits communication among the components of device 200.

Processor 220 may include a processor, microprocessor, or other type of processing logic that may interpret and execute instructions. In other embodiments, processor 220 may include an application-specific integrated circuit (ASIC), a field-programmable gate array (FPGA), or the like. Memory 230 may include a random access memory (RAM) or another type of dynamic storage device that may store information and instructions, e.g., an application, for execution by processor 220. Memory 230 may also include a read-only (ROM) device or another type of static storage device that may store static information and instructions for use by processor 220. Storage device 250 may include a magnetic and/or optical recording medium.

Input device 260 may include a mechanism that permits an operator to input information to device 200, such as a keyboard, a mouse, a pen, a microphone, voice recognition and/or biometric mechanisms, remote control, etc. Output device 270 may include a mechanism that outputs information to the operator, including a display, a printer, a speaker, etc. Communication interface 280 may include a transceiver that enables device 200 to communicate with other devices and/or systems. For example, communication interface 280 may include mechanisms for communicating with another device or system via a network, such as network 125.

As described herein, device 200 may perform certain operations in response to processor 220 executing software instructions contained in a computer-readable medium, such as memory 230. A computer-readable medium may be defined as a physical or logical memory device. The software instructions may be read into memory 230 from another computer-readable medium, such as storage device 250, or from another device via communication interface 280. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

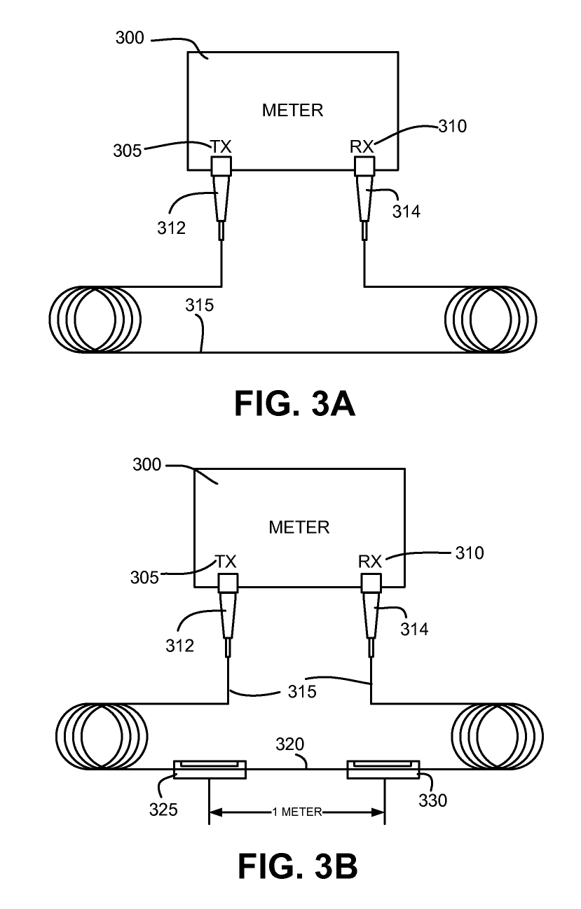

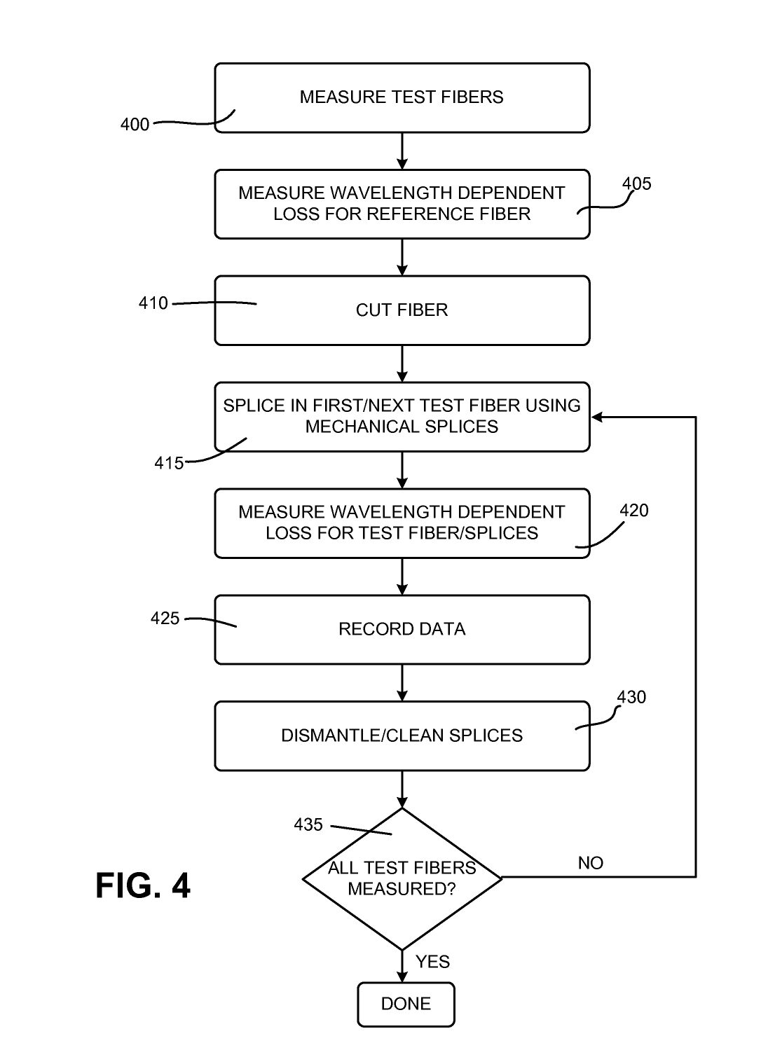

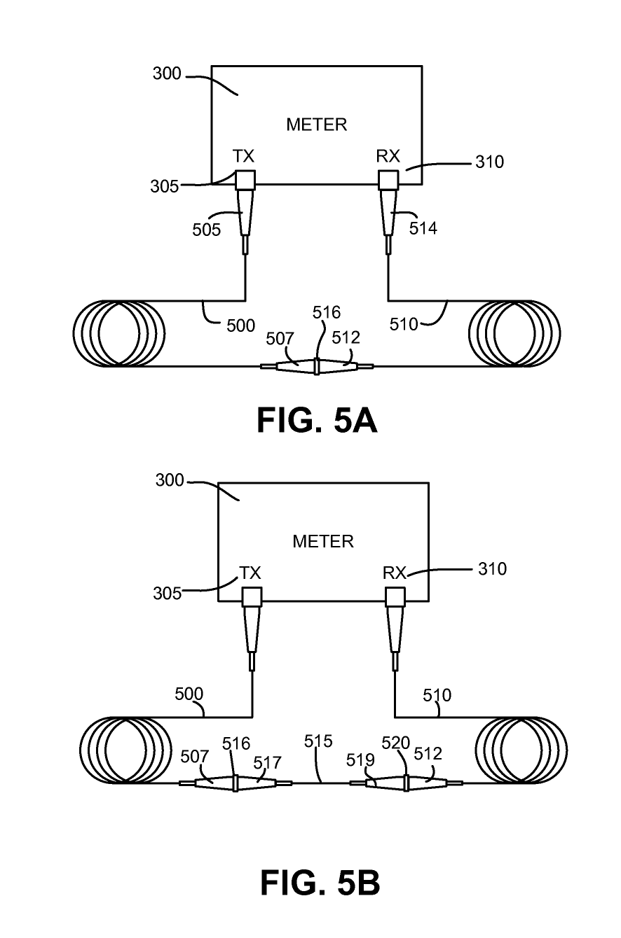

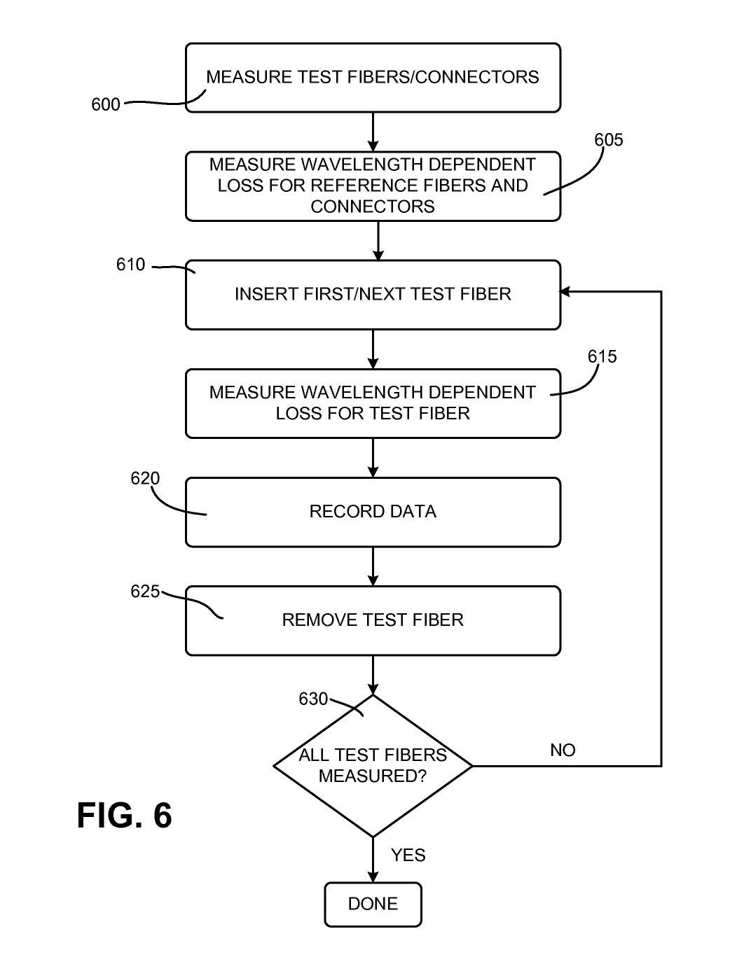

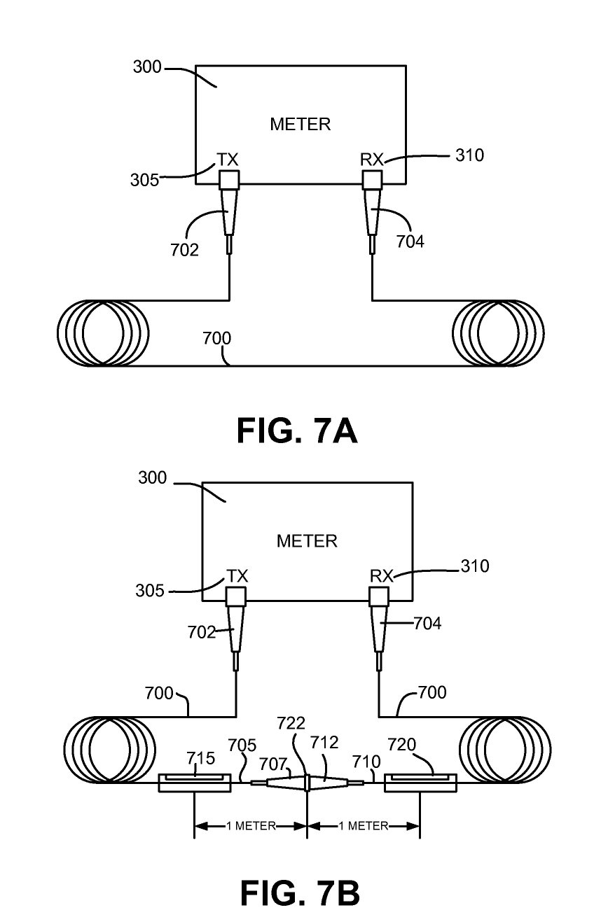

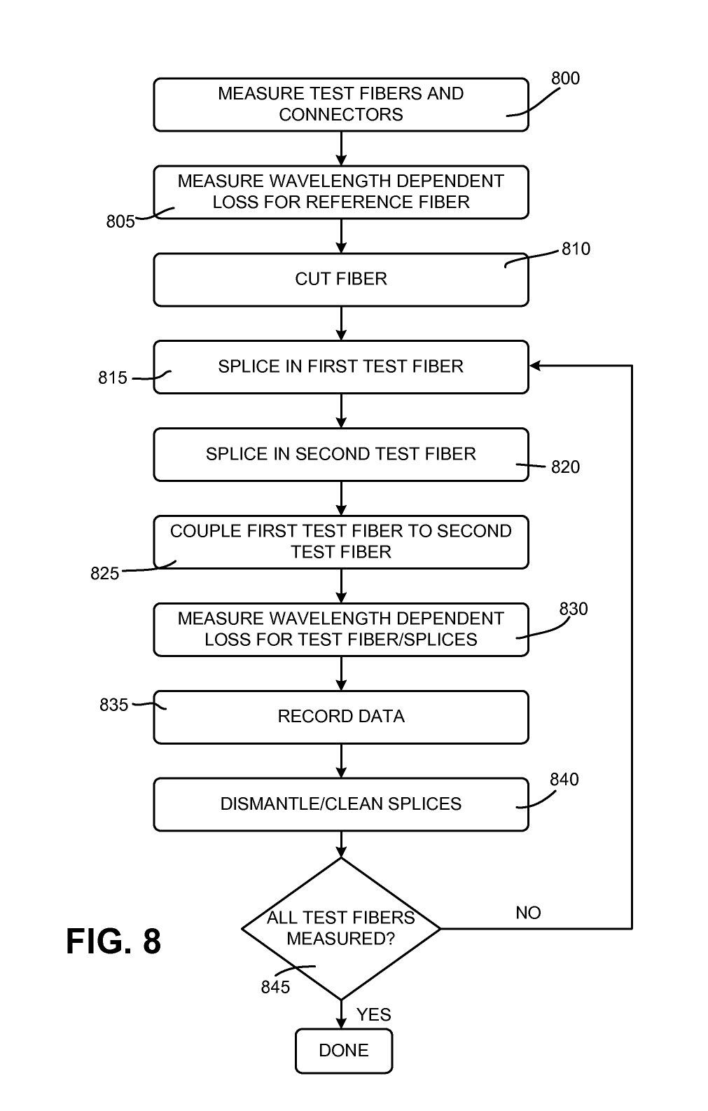

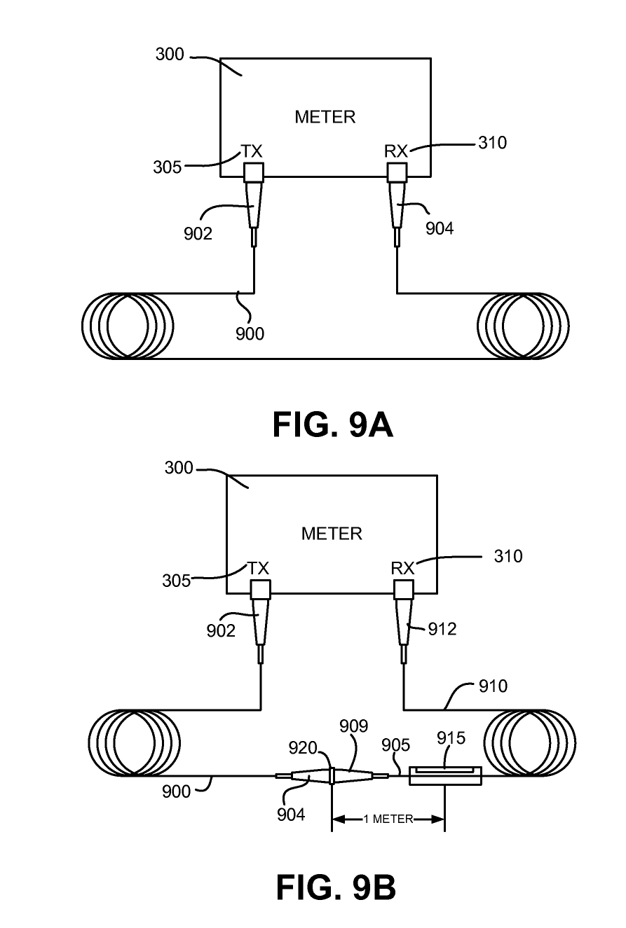

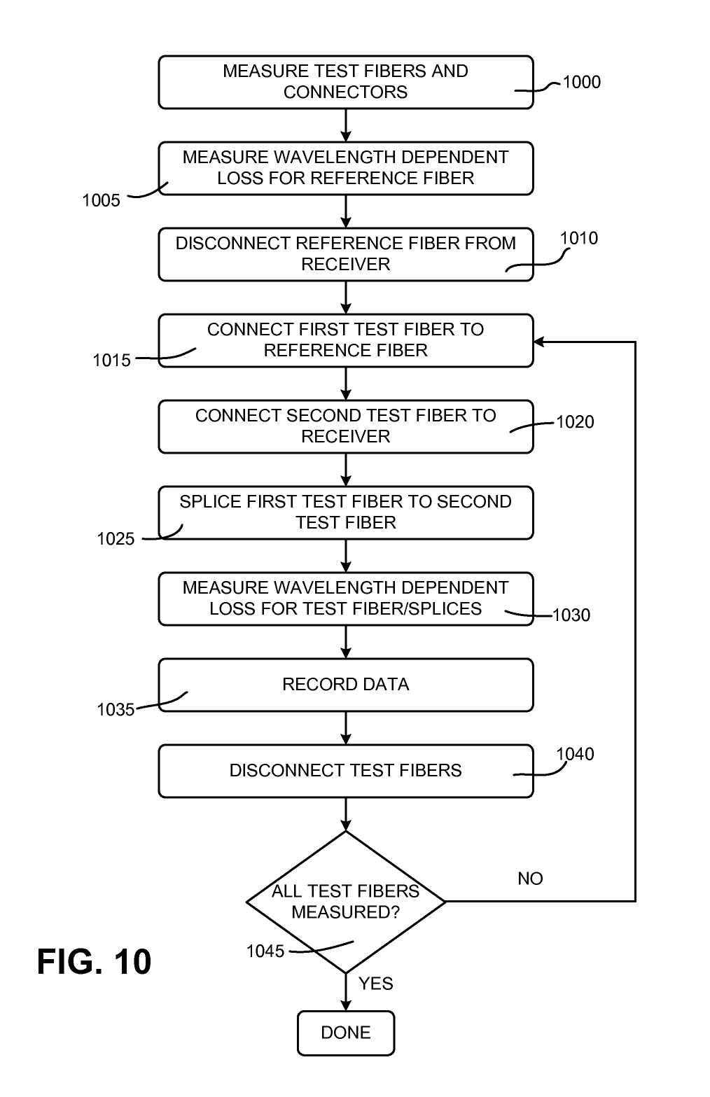

FIGS. 3A through FIG. 10 describe devices and processing associated with fiber/splice testing system 105 for capturing fiber test data in the manner briefly described above. More specifically, FIGS. 3A and 3B are schematic block diagrams illustrating a first fiber test data collection technique. FIG. 4 is a flow diagram illustrating exemplary processing associated with the first fiber test data collection technique. FIGS. 5A and 5B are schematic block diagrams illustrating a second fiber test data collection technique. FIG. 6 is a flow diagram illustrating exemplary processing associated with the second fiber test data collection technique. FIGS. 7A and 7B are schematic block diagrams illustrating a third fiber test data collection technique. FIG. 8 is a flow diagram illustrating exemplary processing associated with the third fiber test data collection technique. FIGS. 9A and 9B are schematic block diagrams illustrating a fourth fiber test data collection technique. FIG. 10 is a flow diagram illustrating exemplary processing associated with the fourth fiber test data collection technique.

Referring to FIGS. 3A, 3B, and 4, fiber/splice testing system 105 may include a meter 300 having an optical signal transmitter 305 and a receiver 310, a reference fiber 315, a test fiber 320, and first and second mechanical splice connectors 325 and 330. As described above, meter 300 may include any suitable device (or combination of devices) for outputting a test optical signal into an optical fiber, receiving the test signal, and measuring optical power losses associated with test signal. An exemplary meter 300 may include a spectrum analyzer.

Prior to collecting data using meter 300, data for a number of test fibers 320 may be measured (block 400). Each test fiber 320 may be one of a number of test fibers measured in a manner consistent with implementations described herein. For example, for each test fiber 320, fiber eccentricity values may be measured and be associated with the test fiber's manufacturer, type, length, etc. In exemplary embodiments, ten or more test fibers may be tested and may include at least a 1.0 m single mode (SM) fiber cord, and a 1.0 m long carbon coated patch cord. Carbon coated fibers may include a moisture protecting coating.

The term “eccentricity” refers to an axial offset between an optical fibers core and its cladding. An optical fiber is typically comprised of at least a core portion and a cladding portion that together define the light guide for the optical fiber, with the cladding portion having an index of refraction lower than that of the core. This causes the optical signals traveling in the core portion to internally reflect from the interface between the core portion and the cladding portion and propagate along the fiber.

Although optimally constructed in a perfectly concentric manner, in many instances the longitudinal axis of the core portion is offset from the longitudinal axis of the cladding portion. This offset defines the eccentricity of the fiber. A “good” fiber eccentricity is on the order of approximately 0.0x micrometers (μm) (e.g., 0.03 μm), while a “poor” fiber eccentricity is on the order of approximately. 0.8x μm (e.g., 0.8 μm). As described below, test fibers 320 having a number of measured eccentricities are measured for WDL in a manner consistent with the methodologies defined herein. In some implementations, a maximum acceptable peak-to-peak WDL is approximately 0.4 decibels (dB) above signals having wavelengths ranging from 1260 nm to 1690 nm.

As shown in FIG. 3A, during a reference phase of the first fiber test data collection technique, reference optical fiber 315 may be coupled to transmitter 305 and receiver 310 via premade fiber optic connectors 312 and 314. Exemplary connectors include standard connector/ultra polish connector (SC/UPC) type pigtail connectors, etc. Pre-made fiber connectors, such as SC/UPC connectors, typically include a ferrule body that has a longitudinal bore formed therein. A length of optical fiber is inserted into the ferrule body, so that an end is exposed. An epoxy or other material is then used to secure the fiber concentrically within the ferrule body, so that the optical fiber is centered within the ferrule opening. The ferrule is mounted within a connector body. The exposed end of the fiber is then cut and polished based on the type of connector being made.

In one exemplary embodiment, reference optical fiber 315 may include a single mode (SM) optical fiber having of a length of at least 7.0 meters long and terminated in premade connectors 312/314. A 7.0 meter long reference fiber 315 may be used to ensure that, in the testing phase, a distance to splices 325/330 from meter 300 is at least 3.5 meters (e.g., a mid-point in reference fiber 315). Fiber lengths less than 3.5 meters are less likely to experience significant wavelength dependent losses and are therefore less useful for determining the suitability of a particular fiber/splice combination.

Meter 300 may measure optical power transmitted through reference fiber 315 (block 405). For example, WDL associated with reference fiber 315 may be measured. For the testing phase of the first fiber test data collection technique, reference optical fiber 315 may be cut at its midpoint (e.g., approximately 3.5 meters (or more) from each respective end) (block 410).

Following cutting of reference fiber 315, a first test fiber 320 may be spliced into each end of cut reference fiber 315 using first mechanical splice connector 325 and second mechanical splice connector 330 (block 415). Two mechanical splice connectors are used to provide a testing mechanism wherein more than two boundary conditions are being tested. Single splice testing (e.g., having only two boundary conditions) has been determined to exhibit insufficient mode coupling.

As described briefly above, mechanical splicing of optical fibers 315 and 320 may be performed by cleaving and polishing and/or cleaning the ends of the respective fibers, placing the fiber ends within mechanical splice connectors 325/330 designed to align the ends of the respective fibers. In some embodiments, the fiber ends are placed in an index matching gel within connectors 325/330 to the facilitate low signal loss from fiber 315 to the test fiber 320 caused by differences in refractive index for each of the fibers. Once the ends of fibers 315 and 320 are aligned and placed into physical proximity in mechanical splice connectors 325/330, connectors 325 and 330 may be locked down or clamped to prevent subsequent movement of the fiber ends.

Once first test fiber 320 has been spliced into reference fiber 315 with mechanical splice connectors 325 and 330, an optical power measurement may be made using meter 300 for a range of wavelengths (block 420). For example, a measurement or calculation of WDL associated with splices 325/330 and test fiber 320 may be made by meter 300 for wavelengths ranging from approximately 1260 nanometers (nm) to approximately 1630 nm. An exemplary measurement interval may include a 5 nm interval. That is, meter 300 may output test signals via transmitter 305 every 5 nm throughout the 1260 nm to 1630 nm range, resulting in at least 75 WDL measurements/calculations. In some instances, a number of measurements may be made for each wavelength to account for statistical anomalies or variations.

As each measurement is made for test fiber 320, the data for the particular test fiber 320 may be automatically recorded and stored (block 425). For example, a record of WDL measurements and/or calculations for the particular brand or type of test fiber 320 may be transmitted from fiber/splice testing system 105 to testing data storage device 110 for use by fiber optimization system 115. The testing data may include the brand/manufacturer of the test fiber, the eccentricity of the test fiber, and the WDL measurements/calculations for each wavelength in the range of test wavelengths.

Splices 325/330 may then be dismantled and the exposed ends of reference fiber 315 and splice connectors 325/330 may be cleaned in preparation for a next test fiber 320 (block 430). It is then determined whether additional test fibers 320 remain to be tested (block 435). That is, it is determined whether all test fibers 320 have undergone splicing and WDL testing for the defined range of wavelengths. If so (block 435—YES), processing for the first fiber test data collection technique is completed. Otherwise (block 435—NO), processing returns to block 415 for the next test fiber 320.

Referring to FIGS. 5A, 5B, and 6, in the second fiber test data collection technique, fiber/splice testing system 105 may include a first reference fiber 500 terminated in a first and a second premade connectors 505/507 and a second reference fiber 510 terminated in third and fourth premade connectors 512/514. As shown in FIG. 5A, first reference fiber 500 may be coupled to second reference fiber 510 via a first fiber coupler 516 connecting second premade connector 507 to third premade connector 512.

In addition, as shown in FIG. 5B, fiber/splice testing system 105 may include a test fiber patch cord 515 terminated in fifth and sixth premade connectors 517/519. Fifth premade connector 517 may be coupled to second premade connector 507 via first fiber coupler 516 and sixth premade connector 519 may be coupled to third premade connector 512 via a second fiber coupler 520, thereby inserting test fiber patch cord 515 between first reference fiber 500 and second reference fiber 510. Unlike the first fiber test data collection technique described above with respect to FIGS. 3A, 3B, and 4, fiber/splice testing system 105 in the second fiber test data collection technique does not incorporate any mechanical splices.

Prior to collecting data using meter 300, data for a number of test fiber patch cords 515 may be measured or otherwise obtained (e.g., from product datasheets, etc.) (block 600). Each test fiber patch cord 515 may be one of a number of test fiber patch cords measured in a manner consistent with implementations described herein. For example, for each test fiber patch cord 515, fiber/ferrule eccentricity values may be measured for connectors 517/519, ferrule hole sizes may be measured for connectors 517/519, eccentricity for fiber 515 may be measured. These values may be associated with the fiber patch cord's manufacturer, type, length, etc. In exemplary embodiments, ten or more fiber patch cords may be tested and may include at least a 7.0 m single mode (SM) patch cord, a 3.0 m SM patch cord, and a 1.0 m long carbon coated patch cord.

As shown in FIG. 5A, during a reference phase of the first fiber test data collection technique, first reference fiber 500 may be coupled to transmitter 305 via first premade connector 505 and second reference fiber 510 may be coupled to receiver 310 via fourth premade connector 512. In addition, second premade connector 507 on first reference fiber 500 may be coupled to third premade connector 512 on second reference fiber 510 via first fiber coupler 516. In one exemplary embodiment, first and second reference optical fibers 500/510 may include single mode optical fibers each having a length of at least 3.0 meters.

Meter 300 may measure optical power transmitted through first and second reference fibers 500/510 and connectors 507/512 (block 605). For example, WDL associated with reference fibers 500/510 and connectors 507/512 may be measured. For the testing phase of the second fiber test data collection technique, connector 507 may be decoupled from connector 512 and a first test fiber patch cord 515 may be coupled to first and second reference fibers 500/510 via connectors 517/519 and couplers 516/520 (block 610). As described above, providing two connector interfaces is done to provide a testing mechanism wherein more than two boundary conditions are being tested.

Once first test fiber patch cord 515 has been inserted between into first and second reference fibers 500/510, an optical power measurement may be made using meter 300 for a range of wavelengths (block 615). For example, a measurement or calculation of WDL associated with connectors 517/519 and test fiber patch cord 515 may be made by meter 300 for wavelengths ranging from approximately 1260 nanometers (nm) to approximately 1630 nm at scanning intervals of approximately 5 nm. In some instances, a number of measurements may be made for each wavelength to account for statistical anomalies or variations.

As each measurement is made for test fiber patch cord 515, the data for the particular test fiber patch cord 515 may be automatically recorded and stored (block 620). For example, a record of WDL measurements and/or calculations for the particular brand or type of test fiber patch cord 515 and/or connectors 517/519 may be transmitted from fiber/splice test system 105 to testing data storage 110 for use by fiber optimization system 115. The testing data may include the brand/manufacturer of the test fiber, the eccentricity of the test fiber, and the WDL measurements/calculations for each wavelength in the range of test wavelengths.

Test fiber patch cord 515 may be removed from reference patch cords 500/510 (block 625), e.g., by decoupling connectors 517/519 from couplers 516/520. It is then determined whether additional test fiber patch cords 515 remain to be tested (block 630). That is, it is determined whether all test fiber patch cords 515 have undergone WDL testing for the defined range of wavelengths. If so (block 630—YES), processing for the second fiber test data collection technique is completed. Otherwise (block 630—NO), processing returns to block 610 for the next test fiber patch cord 515.

Referring to FIGS. 7A, 7B, and 8, fiber/splice testing system 105 may include a reference fiber 700 terminated in first and second premade connectors 702/704, a first test fiber 705 terminated in a third premade connector 707, a second test fiber 710 terminated in a fourth premade connector 712, first and second mechanical splice connectors 715 and 720, and fiber coupler 722. In some implementations, first and second test fibers 705/710 may be referred to as pigtails, referencing the inclusion of a bare fiber on one end and a premade connector on the other end for each fiber.

Prior to collecting data using meter 300, data for a number of test fibers 705/710 may be measured (block 800). Each test fiber 705/710 may be one of a number of test fibers measured in a manner consistent with implementations described herein. For example, for each test fiber 705/710, fiber/ferrule eccentricity values may be measured for connectors 707/712, ferrule hole sizes may be measured for connectors 707/712, and eccentricity for fibers 705/710 may be measured and associated with the test fiber's manufacturer, type, length, etc. In exemplary embodiments, ten or more test fibers 705/710 may be tested and may include at least 1.0 m single mode (SM) fibers, and 1.0 m long carbon coated fibers.

As shown in FIG. 7A, during a reference phase of the first fiber test data collection technique, reference optical fiber 700 may be coupled to transmitter 305 and receiver 310 via premade connectors 702 and 704. Exemplary connectors include SC/UPC connectors, although other types of fiber connectors may be used. In one exemplary embodiment, reference optical fiber 700 may include a SM optical fiber having of a length of at least 7.0 meters.

Meter 300 may measure optical power transmitted through reference fiber 700 (block 805). For example, WDL associated with reference fiber 700 may be measured. For the testing phase of the third fiber test data collection technique, reference optical fiber 700 may be cut at its midpoint (e.g., approximately 3.5 meters (or more) from each respective end) (block 810).

Following cutting of reference fiber 700, one of the first test fibers 705 may be spliced into a first end of cut reference fiber 700 using first mechanical splice connector 715 (block 815) and one of the second test fibers 710 may be spliced into the second end of the cut reference fiber 700 using second mechanical splice connector 720 (block 820). Third premade connector 707 on first test fiber 705 may be coupled to fourth premade connector 712 on second test fiber 710 via fiber coupler 722 (block 825).

Once test fibers 705/710 have been spliced into reference fiber 700 with mechanical splice connectors 715 and 720 and connected to each other via coupler 722, an optical power measurement may be made using meter 300 for a range of wavelengths (block 830). For example, a measurement or calculation of WDL associated with splices 715/720, connectors 707/712, and test fibers 705/710 may be made by meter 300 for wavelengths ranging from approximately 1260 nanometers (nm) to approximately 1670 nm at an exemplary scanning interval of approximately 5 nm. In some instances, a number of measurements may be made for each wavelength to account for statistical anomalies or variations.

As each measurement is made for test fibers 705/710, the data for the particular test fibers 705/710 may be automatically recorded and stored (block 835). For example, a record of WDL measurements and/or calculations for the particular brand or type of test fibers 705/710 may be transmitted from fiber/splice test system 105 to testing data storage 110 for use by fiber optimization system 115. The testing data may include the brand/manufacturer of the test fiber, the eccentricity of the test fiber, and the WDL measurements/calculations for each wavelength in the range of test wavelengths.

Splices 715/720 may then be dismantled and the exposed ends of reference fiber 700 and splice connectors 715/720 may be cleaned in preparation for a next set of test fibers 705/710 (block 840). It is then determined whether additional test fibers 705/710 remain to be tested (block 845). That is, it is determined whether all test fibers 705/710 have undergone splicing and WDL testing for the defined range of wavelengths. If so (block 845—YES), processing for the first fiber test data collection technique is completed. Otherwise (block 875—NO), processing returns to block 815 for the next set of test fibers 705/710.

Referring to FIGS. 9A, 9B, and 10, fiber/splice testing system 105 may include a reference fiber 900 terminated in first and second premade connectors 902/904, a first test fiber 905 terminated in a third premade connector 909, a second test fiber 910 terminated in a fourth premade connector 912, a mechanical splice connector 915, and fiber coupler 920. In some implementations, first and second test fibers 905/910 may be referred to as pigtails, referencing the inclusion of a bare fiber on one end and a premade connector on the other end for each fiber.

Prior to collecting data using meter 300, data for a number of test fibers 905/910 may be measured (block 1000). Each test fiber 905/910 may be one of a number of test fibers measured in a manner consistent with implementations described herein. For example, for each test fiber 905/910, fiber/ferrule eccentricity values may be measured for connectors 909/912, ferrule hole sizes may be measured for connectors 909/912, and eccentricity for fibers 905/910 may be measured and associated with the test fiber's manufacturer, type, length, etc. In exemplary embodiments, ten or more test fiber may be tested and may include at least 1.0 m single mode (SM) fibers, and 1.0 m long carbon coated fibers for first test fiber 905 and a 3.5 m SM and carbon coated fibers for second test fiber 910.

As shown in FIG. 9A, during a reference phase of the first fiber test data collection technique, reference optical fiber 900 may be coupled to transmitter 305 and receiver 310 via premade connectors 902 and 904. Exemplary connectors include SC/UPC connectors, although other types of fiber connectors may be used. In one exemplary embodiment, reference optical fiber 900 may include a SM optical fiber having of a length of at least 7.0 meters.

Meter 300 may measure optical power transmitted through reference fiber 900 (block 1005). For example, WDL associated with reference fiber 900 may be measured. For the testing phase of the third fiber test data collection technique, second premade connector 904 may be disconnected from receiver 310 (block 1010). Third premade connector 909 on one of first test fibers 905 may be connected to second premade connector 904 via fiber coupler 920 (block 1015). Fourth premade connector 912 on one of second test fibers 910 may be connected to receiver 310 (block 1020). The free ends of the selected first and second test fibers 905/910 may be spliced together using mechanical splice connector 915 (block 1025).

Following connection and insertion of the selected first and second test fibers 905/910, an optical power measurement may be made using meter 300 for a range of wavelengths (block 1030). For example, a measurement or calculation of WDL associated with mechanical splice 915, connectors 909/912, and test fibers 905/910 may be made by meter 300 for wavelengths ranging from approximately 1260 nanometers (nm) to approximately 1690 nm at an exemplary scanning interval of approximately 5 nm. In some instances, a number of measurements may be made for each wavelength to account for statistical anomalies or variations.

As each measurement is made for test fibers 905/910, the data for the particular test fibers 905/910 may be automatically recorded and stored (block 1035). For example, a record of WDL measurements and/or calculations for the particular brand or type of test fibers 905/910 may be transmitted from fiber/splice test system 105 to testing data storage 110 for use by fiber optimization system 115. The testing data may include the brand/manufacturer of the test fiber, the eccentricity of the test fiber, and the WDL measurements/calculations for each wavelength in the range of test wavelengths.

Test fibers 905/910 may be disconnected from connector 904 and receiver 310, respectively, in preparation for a next set of test fibers 905/910 (block 1040). In some implementations, one of test fibers 905/910 may be maintained for a subsequent test, with only the other of the test fibers 905/910 being disconnected. In this circumstance, mechanical splice 915 may be dismantled and the exposed end of the remaining test fiber 905/910 may be cleaned for the next test.

It is then determined whether additional test fibers 905/910 remain to be tested (block 1045). That is, it is determined whether all test fibers 905/910 have undergone splicing and WDL testing for the defined range of wavelengths. If so (block 1045—YES), processing for the first fiber test data collection technique is completed. Otherwise (block 1045—NO), processing returns to block 1015 for the next test fiber 920.

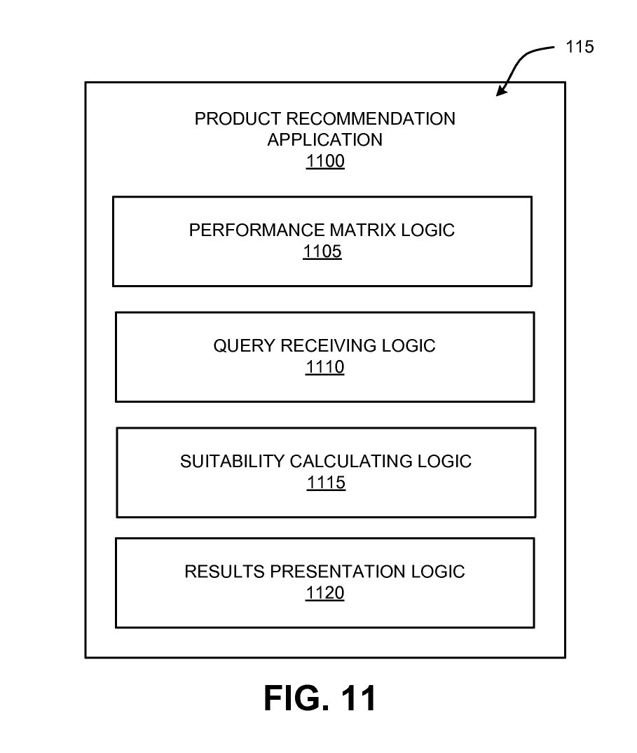

FIG. 11 is a functional block diagram of exemplary components implemented in fiber optimization system 115 of FIG. 1. The logical blocks illustrated in FIG. 11 may be implemented in software, hardware, a combination of hardware and software. In alternative implementations, some or all of the components illustrated in FIG. 11 may be implemented in other devices or combinations of devices, such as fiber/splice testing system 105, user device 120, and/or other devices (e.g., server devices, firewalls, access points, routers, etc.).

Referring to FIG. 11, fiber optimization system 115 may include a product recommendation application 1100 that includes performance matrix logic 1105, query receiving logic 1110, suitability calculating logic 1115, and results presentation logic 1120. Various logic components illustrated in FIG. 11 may be implemented by processor 220 executing one or more programs stored in memory 230. In some implementations, one or more components of FIG. 11 may be implemented in other devices associated with fiber optimization system 115. In addition, product recommendation application 1100 may include a single or more than one executable application. Furthermore, in some implementations, fiber optimization system 115 may be implemented as an application server configured to execute product recommendation application 1100 remotely on, e.g., user device 120.

Product recommendation application 1100 may be configured to generate a performance matrix that includes or references the testing data captured via fiber/splice testing system 105 and stored in testing data storage 110. The performance matrix may provide a resource for product recommendation application 1100 to use when making product recommendations to users. Product recommendation application 1100 may receive product recommendation requests from a user of user device 120 via network 125. For example, a user may be associated with an optical fiber equipment/materials vendor, installer, contractor, technician, etc. At times, the user may wish to determine what equipment and products to use for a particular installation or installation scenario. For example, given a particular fiber run length and splice type, a user may wish to determine acceptable fiber vendors or particular fiber products.

Consistent with implementations described herein, product recommendation application 1100 may receive parameters from the user and may, based on the generated performance matrix, determine one or more acceptable products or product combinations. Product recommendation application 1100 may then transmit information regarding the identified product or products to user device 120 for display to the user.

Referring to FIG. 11, performance matrix logic 1105 may include logic configured to generate or calculate a matrix based on the fiber/splice testing data stored in testing data storage 110. For example, performance matrix logic 1105 may be configured to establish one or more product information matrices comparing fiber types to splice types, fiber vendors to connector types, fiber vendors to fiber lengths, etc. The performance matrix may be used as a basis for determining recommendations by suitability calculating logic 1115. More specifically, in some implementations, the performance matrix may include values for WDL for a number of different fiber types, lengths, brands, connector types, etc. In some instances, the value for WDL for each combination of elements may be determined via direct measurement in the manner described above in relation to FIG. 3A through FIG. 10.

In other instances, the value for WDL for some combinations of elements may be determined via inferential calculations based on the test data stored in testing data storage 110. As described above, WDL greater than a certain threshold may be determined to be unacceptable for particular uses or installations, such as for use in delivering high quality, telecommunications, video, and Internet services.

Query receiving logic 1110 may be configured to receive a query from user device 120 via network 125. Queries received via query receiving logic 1110 may include at least one parameter or criterion, such as installation type, fiber type, fiber vendor, fiber length(s), etc. In some implementations, query receiving logic 1110 may be configured to receive either 1) a suitability query (e.g., a query to determine whether a provided collection of products are suitable for an installation) or 2) a recommendation query (e.g., a query to recommend one or more products based on provided information about the installation). As described briefly above, in some implementations, query receiving logic 1110 may include a web server or application server for receiving query information via network 125.

For suitability queries, suitability calculating logic 1115 may be configured to determine, based on the performance matrix and the received suitability query elements, whether the installation products provided in the query are suitable for the particular installation. That is, suitability calculating logic 1115 may determine whether a predicted WDL for the provided combination of products or materials meets or exceeds a predefined quality threshold, such as, for example, 0.4 dB.

Service providers and/or installers may submit a query that includes information regarding a proposed or planned installation, such as fiber types, connector types, fiber run lengths, etc. Suitability calculating logic 1115 may look up the received information in the performance matrix and determine whether the WDL for the provided combination of products or materials is greater than or less than 0.4 dB. If the predicted WDL is less than 0.4 dB, suitability calculating logic 1115 may determine that the installation products provided in the query are suitable for the particular installation. However, if the predicted WDL is greater than 0.4 dB, suitability calculating logic 1115 may determine that the installation products provided in the query are not suitable for the particular installation. In some instances, when it is determined that the installation products provided in the query are not suitable for the particular installation, suitability calculating logic 1115 may identify recommendations, e.g., product or materials recommendations, that will make the installation acceptable.

For recommendation queries, suitability calculating logic 1115 may be configured to determine, based on the performance matrix and the received recommendation query elements (e.g., installation parameters, requirements, other components, etc.), one or more additional or modified products or materials to satisfy requirements for an installation. That is, suitability calculating logic 1115 may identify one or more additional or modified products that result in a predicted WDL that meets or exceeds the predefined quality threshold, such as approximately 0.4 dB. In some implementations, more than one recommended combination of products or materials that meet the quality requirements (e.g., the WDL requirements) may be identified. When this occurs, suitability calculating logic 1115 may provide the multiple recommendations to results presentation logic 1120. The recommendations may be ranked based on various factors, such as material cost, complexity, etc.

Results presentation logic 1120 may be configured to output the results or recommendations generated by suitability calculating logic 1115. For example, results presentation logic 1120 may include web server logic for formatting and outputting the results or recommendations via network 125.

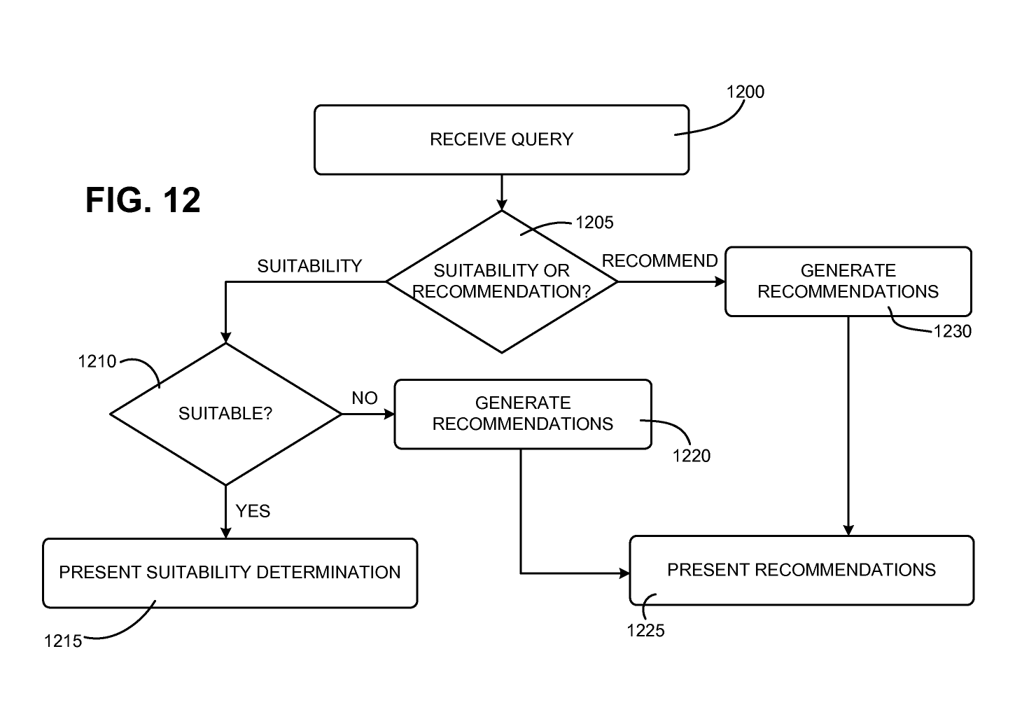

FIG. 12 is a flow diagram illustrating exemplary processing associated with providing fiber and equipment suitability calculations and/or recommendations consistent with implementations described herein. Processing may begin with fiber optimization system 115 receiving a suitability/recommendation query from user device 120 via network 125 (block 1200). For example, query receiving logic 1110 in fiber optimization system 115 may receive query information from user device 120.

As described above, user device 120 may include a web browser or other application for receiving one or more product parameters or criteria from a user. The product parameters may include installation type information, fiber type information, fiber length information, connector type information, fiber brand information, etc. Furthermore, as described above, the provided information may form a suitability query or a recommendation query.

It may be determined whether the query is a suitability query or a recommendation query (block 1205). For example, suitability calculating logic 1115 may determine whether the received query information is a suitability query or a recommendation query by, for example, examining information contained within the query. For queries including complete installation information, it may be determined that the query is a suitability query. However, for query information that is deficient in at least one element, it may be determined that the query is a recommendation query.

When it is determined that the query is a suitability query (block 1205—SUITABILITY), fiber optimization system 115 may determine whether the provided query information describes a suitable installation (block 1210). For example, suitability calculating logic 1115 may determine whether a predicted WDL for the provided installation is less than or equal to a threshold WDL. If so (block 1210—YES), fiber optimization system 115 may present the suitability determination to user device 120 via network 125 (block 1215). That is, results presentation logic 1120 may format and transmit the suitability determination to user device 120, such as via a web page.

If it is determined that the provided query information does not describe a suitable installation (block 1210—NO), fiber optimization system 115 may generate one or more recommendations for transforming the provided installation information to a suitable installation (block 1220). For example, suitability calculating logic 1115 may identify one or more additions or changes to the provided installation information that render the installation suitable. The identified recommendation or recommendations may be provided to user device (block 1225).

Returning to block 1205, when it is determined that the query is a recommendation query (block 1205—RECOMMEND), fiber optimization system 115 may generate one or more recommendations to complete the provided installation information as a suitable installation (block 1230). For example, suitability calculating logic 1115 may identify one or more additions or changes to the provided installation information to make the installation suitable. Processing may proceed to block 1225, where the identified recommendation or recommendations are provided to user device 120.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, implementations have been described above with respect to performing a number of measurements of various optical fiber types, lengths, connectors, etc. to determine wavelength dependent losses associated with the various combinations. However, in other implementations, additional elements may be tested and/or additional measurements may be performed.

In addition, while series of acts have been described with respect to FIGS. 4, 6, 8, 10, and 12 the order of the acts may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding description, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Further, the phrase “based on” is intended to mean “based, at least in part, on” unless explicitly stated otherwise.

What is claimed is:

1. A computing-device implemented method, comprising:
performing one or more measurements for a number of optical fiber components;
storing the one or more measurements;
generating, by at least one processor, a performance matrix based on the one or more measurements,
wherein the performance matrix includes measured and estimated performance metrics for combinations of the number of optical fiber components; and
performing one of:
determining suitability of a planned fiber optic installation that includes a number of components based on the performance matrix; or
determining one or more recommended fiber optic components based on the performance matrix.

2. The computing-device implemented method of claim 1, wherein the performance metrics comprise at least wavelength dependent loss (WDL).

3. The computing-device implemented method of claim 2, wherein determining suitability of a planned fiber optic installation, further comprises:
determining suitability based on the wavelength dependent loss of the number of components.

4. The computing-device implemented method of claim 2, wherein determining one or more recommended fiber optic components, further comprises:
identifying the one or more recommended fiber optic components based on the wavelength dependent loss associated with the combinations of the one or more recommended fiber optic components.

5. The computing-device implemented method of claim 1, further comprising:
receiving a suitability query from a user device via a computer network,
wherein the suitability query includes information regarding the planned fiber optic installation; and
outputting information representing the determined suitability of the planned fiber optic installation to the user device.

6. The computing-device implemented method of claim 5, further comprising:
generating one or more recommendations when it is determined that the planned fiber optic installation is not suitable,
wherein the recommendations include changes or additions to the number of components in the received suitability query; and
outputting the one or more recommendations to the user device.

7. The computing-device implemented method of claim 1, further comprising:
receiving a suitability query from a user device via a computer network,
wherein the suitability query includes information regarding the planned fiber optic installation; and
outputting information representing the determined suitability of the planned fiber optic installation to the user device.

8. The computing-device implemented method of claim 1, wherein performing one or more measurements for a number of optical fiber components further comprises:
performing a first fiber test data collection for a first set of optical fiber components;
performing a second fiber test data collection for a second set of optical fiber components;
performing a third fiber test data collection for a third set of optical fiber components; and
performing a fourth fiber test data collection for a fourth set of optical fiber components.

9. The computing-device implemented method of claim 8, wherein performing the first fiber test data collection comprises:
measuring the performance metric for a reference optical fiber;
splicing in a test optical fiber using at least two mechanical splices;
measuring the performance metric for the test optical fiber and the at least two mechanical splices; and
performing the splicing and measuring for a number of different test optical fibers.

10. The computing-device implemented method of claim 9, wherein the number of test optical fibers comprises test optical fibers having varying eccentricities.

11. The computing-device implemented method of claim 9, wherein performing the first fiber test data collection further comprises measuring one or more physical characteristics of the test optical fibers and the mechanical splices.

12. The computing-device implemented method of claim 8, wherein performing the second fiber test data collection comprises:
measuring the performance metric for a first reference optical fiber coupled to a second reference fiber via first and second premade optical connectors;
inserting a test optical fiber terminated in third and fourth premade optical connectors between the first reference optical fiber and the second reference optical fiber;
measuring the performance metric for the test optical fiber and the third and fourth premade optical connectors; and
performing the inserting and measuring for a number of different test optical fibers and third and fourth premade optical connectors.

13. The computing-device implemented method of claim 12, wherein performing the second fiber test data collection further comprises measuring one or more physical characteristics of the test optical fibers and the third and fourth premade optical connectors.

14. The computing-device implemented method of claim 8, wherein performing the third fiber test data collection comprises:
measuring the performance metric for a reference optical fiber;
splicing in a first test optical fiber terminated in a first premade optical connector using a first mechanical splice;
splicing in a second test optical fiber terminated in a second premade optical connector using a second mechanical splice;
coupling the first premade optical connector to the second premade optical connector;
measuring the performance metric for the first test optical fiber, the second test optical fiber, the first and second premade optical connectors, and the first and second mechanical splices; and
performing the splicing, coupling, and measuring for a number of different test optical fibers and first and second premade optical connectors.

15. The computing-device implemented method of claim 14, wherein performing the third fiber test data collection further comprises measuring one or more physical characteristics of the test optical fibers, the first and second premade optical connectors, and the first and second mechanical splices.

16. The computing-device implemented method of claim 8, wherein performing the fourth fiber test data collection comprises:
measuring the performance metric for a reference optical fiber connected to a testing device via first and second premade optical connectors;
splicing a first test optical fiber terminated in a third premade optical connector to a second test optical fiber terminated in a fourth premade optical connector using a mechanical splice;
coupling the third premade optical connector of the first test optical fiber to the testing device and the fourth premade optical connector of the second test optical fiber to the second premade optical connector of the reference optical fiber;
measuring the performance metric for the first test optical fiber, the second test optical fiber, the third and fourth premade optical connectors, and the mechanical splice; and
performing the splicing, coupling, and measuring for a number of different test optical fibers and first and second premade optical connectors.

17. The computing-device implemented method of claim 16, wherein performing the fourth fiber test data collection further comprises measuring one or more physical characteristics of the test optical fibers, the third and fourth premade optical connectors, and the mechanical splice.

18. A system, comprising:
an optical fiber component testing system for performing one or more measurements for a number of optical fiber components;
a storage to automatically receive the one or more measurements from the optical fiber component testing system; and
an optical fiber optimization system, comprising:
a communication interface; and
logic to:
generate a performance matrix based on the one or more measurements,
wherein the performance matrix includes measured and estimated performance metrics for combinations of the number of optical fiber components; and
receive a suitability query from a user device via the communication interface;
determine suitability of a planned fiber optic installation that includes a number of components based on the performance matrix;
receive a recommendation query from the user device via the communication interface;
determine one or more recommended fiber optic components based on the performance matrix; and
transmit an indication of the suitability or the recommended fiber optic components to the user device via the communication interface.

19. The system of claim 18, wherein the performance metrics comprise at least wavelength dependent loss (WDL).

20. A computer-readable memory device including instructions executable by at least one processor, the computer-readable memory device comprising one or more instructions to:
automatically generate at least one performance matrix based on testing of a number of different optical fibers and optical fiber components,
wherein the at least one performance matrix includes measured and estimated performance metrics for combinations of the number of optical fibers and optical fiber components;
receive one of a suitability query or a recommendation query from a user device via a computer network;
determine, for a suitability query, a suitability of a planned fiber optic installation that includes a number of components based on the at least one performance matrix;
determine, for a recommendation query, one or more recommended fiber optic components based on the performance matrix; and
output an indication of the suitability or the recommended fiber optic components to the user device via the computer network.
